(19) United States
(12) Patent Application Publication
(10) Pub. No.: US 2014/0019904 A1
(43) Pub. Date: Jan. 16, 2014

(54) METHOD FOR PROVIDING DATA ASSOCIATED WITH AN OBJECT DISPLAYED ON A TOUCH SCREEN DISPLAY

(71) Applicant: Jean-Baptiste Martinoli, St-Anaclet de Lessard (CA)

(72) Inventor: Jean-Baptiste Martinoli, St-Anaclet de Lessard (CA)

(73) Assignee: EXO U INC., Montreal, QC (CA)

(21) Appl. No.: 13/985,566

(22) PCT Filed: Jan. 31, 2012
(86) PCT No.: PCT/CA2012/000083

§ 371 Date: Sep. 24, 2013

Related U.S. Application Data
(60) Provisional application No. 61/443,081, filed on Feb. 15, 2011.

(51) Int. Cl. G06F 3/0488

(52) U.S. Cl. CPC G06F 3/04886
USPC 715/773

(57) ABSTRACT

A method for providing data associated with an object displayed on a touch screen display, the method including detecting a physical contact with the object displayed on the touch screen display, detecting a given finger gesture generated following the physical contact and providing data associated with the given finger gesture and the object displayed.

### CROSS-REFERENCE TO RELATED APPLICATIONS

This application claims priority of U.S. Provisional Patent Application No. 61/443,081 entitled “Method for providing data associated with an object displayed on a touch screen panel” that was filed on Feb. 15, 2011, the specification of which is hereby incorporated by reference.

### FIELD OF THE INVENTION

The invention relates to the field of computing devices having a touch screen panel. More precisely, this invention pertains to a method for providing data associated with an object displayed on a touch screen display.

### BACKGROUND

There exist today many types of input devices for performing operations in a computer device having a touch screen display.

Unfortunately, the interactions with the computer device are still cumbersome in some cases.

For instance, in the case of a keyboard, being able to type a specific key or a character on a keyboard displayed on a touch screen display may still be cumbersome.

In fact, the skilled addressee will appreciate that while it may be easy to enter a key with a standard keyboard, the display of a keyboard on the touch screen display will bring limitations inexistent with standard keyboards.

In fact, a user may be faced with delays when combinations of keys are required and great frustration may arise as a consequence from the use of such keyboard displayed. As a direct consequence, a user experience with a keyboard displayed on the touch screen display may be spoiled.

There is a need for a method that will overcome at least one of the above identified drawbacks.

Features of the invention will be apparent from review of the disclosure, drawings and description of the invention below.

### BRIEF SUMMARY

According to a first aspect of the invention, there is disclosed a method for providing data associated with an object displayed on a touch screen display, the method comprising detecting a physical contact with the object displayed on the touch screen display; detecting a given finger gesture generated following the physical contact; and providing data associated with the given finger gesture and the object displayed.

In accordance with one embodiment, the object comprises a key of a keyboard.

In accordance with another embodiment, the detecting of a given finger gesture generated following the physical contact comprises identifying a motion direction and measuring a duration of a motion.

In accordance with another embodiment, the motion direction of the given finger gesture is selected from a group consisting of a 0 degree direction motion, a 90 degree direction motion and a 180 degree direction motion.

In accordance with another embodiment, the duration of the motion is measured from the start of the motion to the end of the motion.

In accordance with another embodiment, the measuring of the duration of the motion comprises detecting a given distance covered after the start of the motion.

In accordance with another embodiment, the given finger gesture is detected from a group of finger gestures and each finger gesture depends on the object.

In accordance with another embodiment, the providing of the data associated with the given finger gesture and the key of the keyboard comprises identifying a function associated with the finger gesture; accessing a table with the function identified and the key of the keyboard; retrieving from the table data associated with the function identified and the key of the keyboard.

In accordance with another embodiment, the function comprises a selected key of the keyboard.

In accordance with another embodiment, the selected key is selected from a group consisting of a SHIFT key and a CONTROL key.

In accordance with another embodiment, the data associated with the function identified and the key of the keyboard is a corresponding mapping of the function identified and the key of the keyboard.

In accordance with another embodiment, the method further comprises displaying the corresponding mapping of the function identified and the key of the keyboard.

In accordance with another embodiment, the data comprises one of a value, a character, a string of characters, a batch file, a data file and a program.

In accordance with another embodiment, the object comprises an icon.

In accordance with another embodiment, the given finger gesture detected immediately follows the physical contact with the object displayed on the touch screen display.

In accordance with another embodiment, the given finger gesture is associated with a function for toggling between various states.

In accordance with another embodiment, each state corresponds to a given character font associated with a character displayed on the touch screen display.

In accordance with an aspect of the invention, there is provided a computer-readable storage medium storing computer-executable instructions which, when executed, causes a computing device comprising a touch screen panel to perform a method for interacting with an application comprising detecting a physical contact with an object displayed on the touch screen display; detecting a given finger gesture generated following the physical contact; and providing data associated with the given finger gesture and the object displayed.

In accordance with another aspect of the invention, there is provided a computing device comprising a touch screen display; one or more central processing units; a memory comprising an application; and one or more programs, wherein the one or more programs are stored in the memory and configured to be executed by the one or more central processing units, the one or more programs including: instructions for detecting a physical contact with an object displayed on the touch screen display; instructions for detecting a given finger gesture generated following the physical contact; and instructions for providing data associated with the given finger gesture and the object displayed.

### BRIEF DESCRIPTION OF THE DRAWINGS

In order that the invention may be readily understood, embodiments of the invention are illustrated by way of example in the accompanying drawings.

FIG. 1 is a block diagram which shows an embodiment of a computing device in which an embodiment of a method for providing data associated with an object displayed in a touch screen display may be implemented.

FIG. 2 is a flowchart which shows an embodiment of a method for providing data associated with an object displayed on a touch screen display; according to a first processing step a physical contact with an object is detected; according to a second processing step a given finger gesture is detected and according to a third processing step, data is provided.

FIG. 3 is a flowchart which shows an embodiment of how a given gesture is detected in accordance with an embodiment of the invention.

FIG. 4 is a flowchart which shows how data is provided in accordance with one embodiment of the invention.

FIG. 5 is a schematic which shows an enlarged view of one part of the touch screen display in which a portion of a keyboard is displayed.

FIG. 6A is a schematic which shows a first step of a motion performed by a user finger on an object displayed on a touch screen display.

FIG. 6B is a schematic which shows a second step of a motion performed by a user finger on an object displayed on a touch screen display.

FIG. 6C is a schematic which shows a third step of a motion performed by a user finger on an object displayed on a touch screen display.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

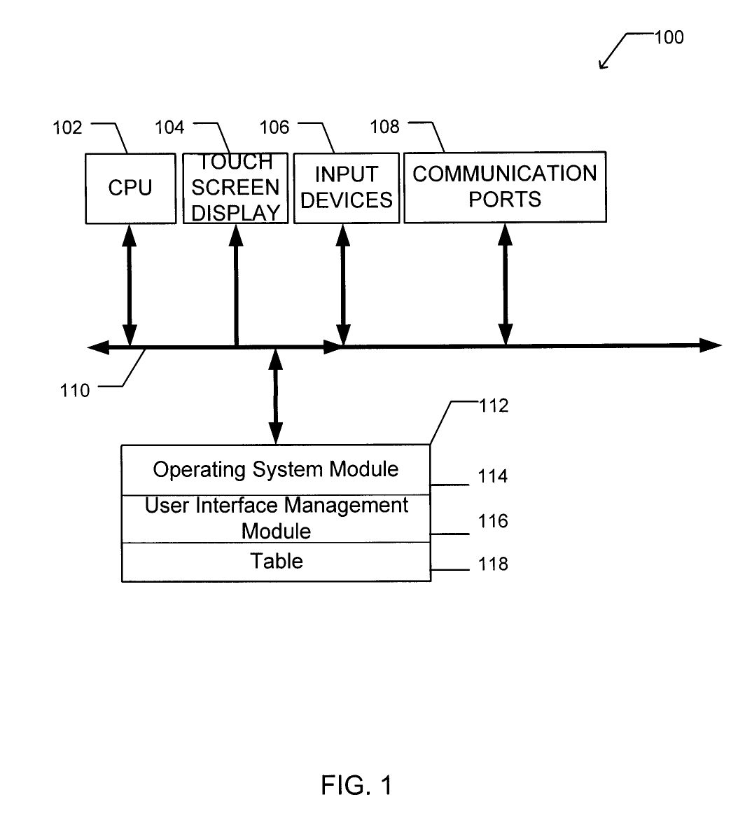

Now referring to FIG. 1, there is shown an embodiment of a computing device 100 in which an embodiment of the method for providing data associated with an object displayed on a touch screen display may be implemented.

In this embodiment the computing device 100 comprises at least one Central Processing Unit (CPU) 102, a touch screen display 104, input devices 106, communication ports 108, a data bus 110 and a memory 112.

The at least one Central Processing Unit (CPU) 102, the touch screen display 104, the input devices 106, communication ports 108 and the memory 112 are connected together using the data bus 110.

In one embodiment the computing device 100 is the ExoPC™ manufactured by Pegatron. Still in this embodiment the at least one Central Processing Unit 102 comprises an Atom Pineview-M N450 manufactured by Intel™, running at 1.66 GHz and supporting 64 bits.

Still in this embodiment, the touch screen display 104 comprises a touch screen panel having 11.6-inch width and a resolution of 1366×768 pixels with 135 pixels per inch. The touch screen panel uses a multipoint capacitive technology known to the ones skilled in the art. The touch screen display 104 further comprises a GMA500 graphics card manufactured by Intel™.

The input devices 106 are used for providing data to the computing device 100.

In this embodiment, the input devices 106 comprise an accelerometer, a microphone, a luminosity sensor and a camera. The skilled addressee will appreciate that various other embodiments for the input devices 106 may alternatively be provided.

The communications ports 108 are used for enabling a communication of the computing device 100 with other devices.

In this embodiment, the communication ports 108 comprise a WIFI 802.11 b/g/n port, a Bluetooth 2.1+EDR port, two USB 2.0 ports, a SD/SDHC card reader and a mini HDMI port. The skilled addressee will again appreciate that various other embodiments may be provided for the communication ports 108.

The memory 112 is used for storing data.

In this embodiment, the memory 112 comprises a Solid State Drive (SSD) having a capacity of either 32 or 64 GB.

More precisely and still in this embodiment, the memory 112 comprises, inter alia, an operating system module 114. The operating system module 114 is Windows 7™ Home Premium Edition manufactured by Microsoft™.

The memory 112 further comprises a user interface management module 116. The user interface management 116 is used for managing the user interface of the computing device 100.

It will be appreciated that the method for providing data associated with an object displayed on a touch screen display may be implemented for instance within the user interface management module 116, i.e. be a component of it and be constituted of one or more programs, wherein the one or more programs are configured to be executed by the at least one Central Processing Unit (CPU) 102, the one or more programs comprising instructions for detecting a physical contact with the object displayed on the touch screen display 104, instructions for detecting a given finger gesture generated following the physical contact and instructions for providing data associated with the given finger gesture and the object displayed on the display device 104.

The memory 112 further comprises a table 118. It will be appreciated that the table 118 may be of various types as further explained below.

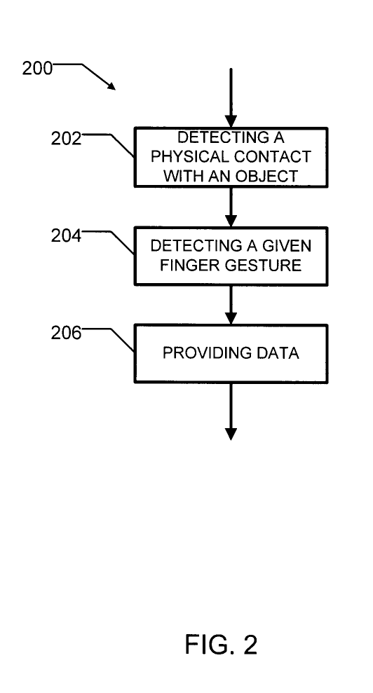

Now referring to FIG. 2, there is shown an embodiment of a method for providing data associated with an object displayed on a touch screen display.

It will be appreciated by the skilled addressee that the data associated with an object may be of various types as explained further below. In fact, it will be appreciated that the method enables a user to provide various data associated with the object depending on a given gesture.

According to processing step 202, a physical contact with an object displayed on the touch screen display is detected.

It will be appreciated that the object may be of various types.

In a preferred embodiment, the object comprises a letter of a keyboard displayed on the touch screen display.

In an alternative embodiment, the object comprises an icon.

It will be appreciated that the physical contact may be detected according to various technologies known to the skilled addressee.

In a preferred embodiment, the physical contact detected is performed by a finger of a user contacting the touch screen display.

Still referring to FIG. 2 and according to processing step 204, a given finger gesture is detected.

It will be appreciated that the given finger gesture is performed immediately after the physical contact with the object in a preferred embodiment i.e. the given finger gesture is performed while a finger is still in contact with the touch screen display, i.e. the user does not remove his finger from the touch screen display after contacting the object and before performing the finger gesture.

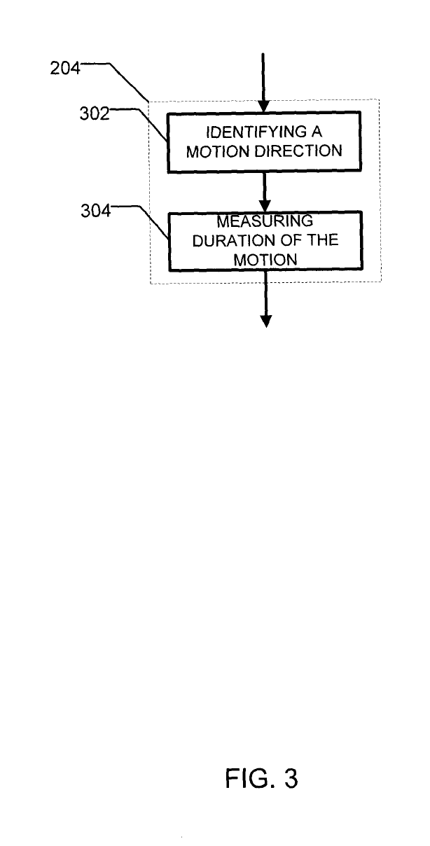

Now referring to FIG. 3, there is shown an embodiment of a method for detecting a given finger gesture.

According to processing step 302 a motion direction is identified.

In one embodiment, the motion direction is selected from a group consisting of a 0 degree direction motion, a 90 degree direction motion, a 180 degree direction motion.

The skilled addressee will appreciate that various alternative embodiments may be provided.

In a preferred embodiment, the motion direction is a 0 degree direction motion.

According to processing step 304, the duration of the motion is measured. It will be appreciated that the duration of the motion may be measured according to various embodiments.

It will be appreciated that the duration of the motion is measured in order to prevent errors of manipulation in one embodiment.

In fact, it will be appreciated that the duration of the motion may be defined in one embodiment as the duration from the start of the motion to the end of the motion. Alternatively, the duration of the motion may be measured by detecting a given distance covered after the start of the motion.

In a preferred embodiment, each of the motion duration and the motion direction is detected using the operating system application programming interfaces (APIs). It will be appreciated that various alternative development tools may enable the support of multi-touch gestures.

It will be appreciated that the group of finger gestures associated with an object may depend on the object per se. For instance a given object may have only two finger gestures associated with it while another object may have four finger gestures associated with it.

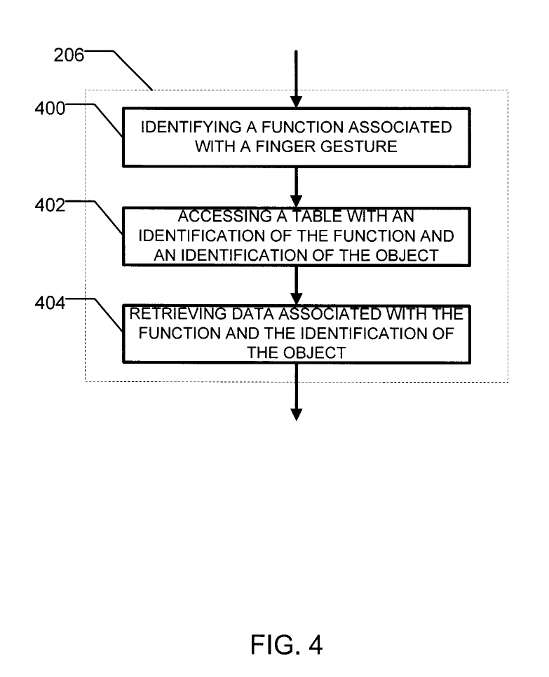

Now referring to FIG. 4, there is shown an embodiment of how to provide data.

According to processing step 400, a function associated with a finger gesture is identified.

In a preferred embodiment, the function is identified using an identification of the object and an identification of the finger gesture detected.

It will be appreciated that the function may be of various types.

According to processing step 402, a table is accessed with an identification of the function and the identification of the object.

It will be appreciated that the table may be located at various locations. In a preferred embodiment, the table is located in the memory 112.

According to processing step 404, data associated with the function and the identification of the object is retrieved.

It will be appreciated that the data may be a value, a character, a string of characters, a batch file, a data file, a program, an action command (such as a screen capture, volume control, etc.) or the like.

In a preferred embodiment, the data is the exact mapping of one of the SHIFT key, the ALT key and the CONTROL key with a corresponding letter or numeral depending on the motion direction.

It will be further appreciated that the data associated with the function and the identification of the object may then be provided to various locations.

In a preferred embodiment, the data associated with the function and the identification of the object is provided to an application handling the keyboard displayed on the touch screen panel.

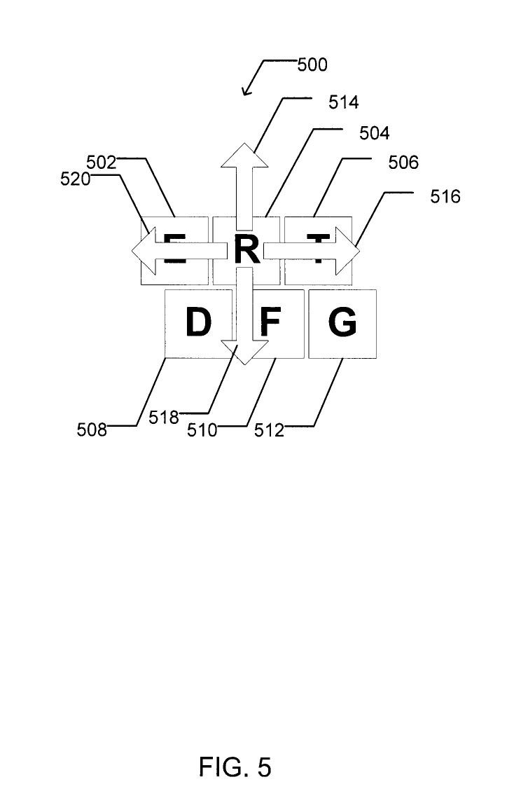

Now referring to FIG. 5, there is shown an embodiment of a touch screen display 500 in which a part of a keyboard is displayed.

The part of the keyboard displayed is comprised of letter “E” 502, letter “R” 504, letter “T” 506, letter “D” 508, letter “F” 510 and letter “G” 512.

In this embodiment, the method disclosed herein is used for providing data associated with a given finger gesture and an object displayed.

In fact, in this embodiment, the object is letter “R” 504.

For understanding purposes, a plurality of arrows symbolizing finger gestures available for letter “R” 504 have been shown in FIG. 4. The skilled addressee will appreciate that those arrows would typically not be displayed on the keyboard.

More precisely and as shown in FIG. 4, a first arrow symbolizing a first finger gesture 514 is displayed. Such first finger gesture 514 could be referred to as a 0 degree direction motion. A second arrow symbolizing a second finger gesture 516 is also displayed. The second finger gesture 516 could be referred to as a 90 degree direction motion. A third arrow symbolizing a third finger gesture 518 is also displayed. The third finger gesture 518 could be referred to as a 180 degree direction motion. A fourth arrow symbolizing a fourth finger gesture 520 is also displayed. The fourth finger gesture 520 could be referred to as a 270 degree direction motion. It will be appreciated that in a preferred embodiment the fourth finger gesture 520 is not used. In an alternative embodiment, the fourth finger may be used.

The skilled addressee will appreciate that while those finger gestures 514, 516, 518 and 520 are associated with letter “R” 504, it will be appreciated that those finger gestures may also be associated with other letters of the keyboard and in particular with letter “E” 502, letter “T” 506, letter “D” 508, letter “F” 510 and letter “G” 512 displayed in FIG. 5.

It will also be appreciated that the function may be a key of a keyboard or a combination of keys of the keyboard.

So for instance, finger gesture 514 may be associated with pressing a “SHIFT” key. In such case, performing finger gesture 514 would result in having providing data associated or representative of “R” (i.e. SHIF+“r”).

Finger gesture 516 may be associated with pressing a “CONTROL” key. In such case, performed finger gesture 516 would results in providing data associated or representative of “CONTROL r”.

Keys such as “FN”, “COMMAND”, “CAPS LOCK”, “ALT” may therefore be associated with a given gesture.

The skilled addressee will readily appreciate that the embodiment disclosed is of great advantage since it greatly increases the interactivity and the speed associated with an interaction with a keyboard displayed on a touch screen panel

Moreover, it will be understood that functions other than existing keyboard keys may be easily associated with a given finger gesture.

For instance, a gesture may be associated with, for instance, a function for toggling between various specific states, each state corresponding to the display of characters in a given font for instance. A user may therefore press a key, perform a corresponding gesture and accordingly toggle to access a desired font. When the desired font is accessed, the user may resume typing on the keyboard until he wishes to change again the font. A corresponding gesture may also used for toggling between various font sizes, etc.

In a preferred embodiment, the finger gesture is used for emulating the “SHIFT” key, the “CONTROL” key and the “ALT” key.

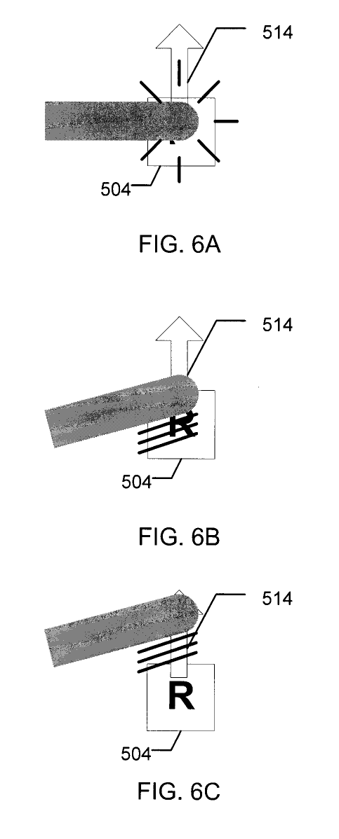

FIG. 6A shows a first step of a motion performed by a user finger on letter “R” 504 displayed on a touch screen panel. In this first processing step, the user has just touched letter “R” 504 on the touch screen panel with his finger.

FIG. 6B shows a second step of a motion performed by a user finger on the letter “R” 504 displayed on a touch screen panel. In this second processing step, the user has started to perform a given finger gesture associated with the letter “R” 504 with his finger.

FIG. 6C shows a third step of a motion performed by a user finger on the letter “R” 504 displayed on a touch screen panel. In this third processing step, the user has just completed the given finger gesture associated with the letter “R” 504.

Also, it will be appreciated that a computer-readable storage medium may be provided for storing computer-executable instructions. Such computer-executable instructions would cause, when executed, a computing device comprising a touch screen display to perform a method for providing data associated with an object displayed on the touch screen display, the method comprising detecting a physical contact with the object displayed on the touch screen display; detecting a given finger gesture generated following the physical contact; and providing data associated with the given finger gesture and the object displayed.

Although the above description relates to a specific preferred embodiment as presently contemplated by the inventor, it will be understood that the invention in its broad aspect includes mechanical and functional equivalents of the elements described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1.-19. (canceled)

20. A method for providing data associated with a key of a keyboard displayed on a touch screen display, the method comprising:
detecting a physical contact with the key of the keyboard displayed on the touch screen display;
detecting a given finger gesture from the key of the keyboard, the given finger gesture generated immediately following the physical contact; and
providing data associated with a combination of the given finger gesture and the key of the keyboard displayed on which a physical contact of the finger is detected.

21. The method as claimed in claim 20, wherein the detecting of a given finger gesture comprises identifying a key on the keyboard where a motion started, determining a motion direction and measuring a duration of a motion.

22. The method as claimed in claim 21, wherein the motion direction of the given finger gesture is selected from a group consisting of a 0 degree direction motion, a 90 degree direction motion, a 180 degree direction motion and a 270 degree direction motion.

23. The method as claimed in claim 21, wherein the duration of the motion is measured from the start of the motion to the end of the motion.

24. The method as claimed in claim 21, wherein the measuring of the duration of the motion comprises detecting a given distance covered after the start of the motion.

25. The method as claimed in claim 20, wherein the given finger gesture is detected from a group of finger gestures, further wherein each finger gesture command depends on the key of the keyboard where the finger motion started.

26. The method as claimed in claim 20, wherein the providing of the data associated with a combination of the given finger gesture and the key of the keyboard displayed on which a physical contact of the finger is detected comprises:
identifying a function associated with the finger gesture;
accessing a table with the function identified and the key of the keyboard;
retrieving from the table data associated with the function identified and the key of the keyboard.

27. The method as claimed in claim 26, wherein the function comprises a selected key of the keyboard.

28. The method as claimed in claim 27, wherein the selected key is selected from a group consisting of a “SHIFT” key, a “ALT” key, a “CONTROL” key, a “FN” key and a “COMMAND” key.

29. The method as claimed in claim 28, wherein the data associated with the function identified and the key of the keyboard is a corresponding mapping of the function identified and the key of the keyboard.

30. The method as claimed in claim 29, further comprising displaying the corresponding mapping of the function identified and the key of the keyboard.

31. The method as claimed in claim 20, wherein the data comprises one of a value, a character, a string of characters, a batch file, a data file and a program.

32. The method as claimed in claim 20, wherein the given finger gesture is associated with a function for toggling between various states.

33. The method as claimed in claim 32, wherein each state corresponds to a given character font associated with a character displayed on the touch screen display.

34. A computer-readable storage medium storing computer-executable instructions which, when executed, causes a computing device comprising a touch screen panel to perform a method for providing data associated with a key of a keyboard, the method comprising:
detecting a physical contact with the key of the keyboard displayed on the touch screen display;
detecting a given finger gesture from the key of the keyboard, the given finger gesture generated immediately following the physical contact; and
providing data associated with a combination of the given finger gesture and the key of the keyboard displayed on which a physical contact of the finger is detected.

35. A computing device, comprising:
a touch screen display;
a central processing unit;
a memory comprising an application; and
a program, wherein the program is stored in the memory and configured to be executed by the central processing unit, the program including:
instructions for detecting a physical contact with a key of the keyboard displayed on the touch screen display;
instructions for detecting a given finger gesture from the key of the keyboard, the given finger gesture generated immediately following the physical contact; and
instructions for providing data associated with a combination of the given finger gesture and the key of the keyboard displayed on which a physical contact of the finger is detected.
